(19) United States
(12) Patent Application Publication
(10) Pub. No.: US 2024/0125901 A1
(43) Pub. Date: Apr. 18, 2024

(54) SYSTEM AND METHOD OF VIBRATION AND AUDIBLE NOISE REDUCTION IN A LIDAR RESONATOR

(71) Applicant: GM GLOBAL TECHNOLOGY OPERATIONS LLC, Detroit, MI (US)

(72) Inventors: Qijun Zhang, Canton, MI (US); Mark A. Stebbins, Bloomfield Twp, MI (US); Srinivasa R. Molleti, Troy, MI (US)

(73) Assignee: GM GLOBAL TECHNOLOGY OPERATIONS LLC, Detroit, MI (US)

(21) Appl. No.: 17/964,444

(22) Filed: Oct. 12, 2022

(51) Int. Cl. G01S 7/481; G01S 7/4865; G01S 17/10; G01S 17/89

(52) U.S. Cl. CPC G01S 7/4811; G01S 7/4817; G01S 7/4865; G01S 17/10; G01S 17/89

(57) ABSTRACT

A system and method of vibration and audible noise reduction in a LiDAR resonator includes a spring fork mechanism including multiple spring forks. Each spring fork includes two tines. The first tine of a first and second spring fork include a mounted optical module to transmit a light pulse and receive a reflection of the light pulse. The second tine of the first and second spring forks include a mounted counterweight having a mass and center of gravity equal to a mass and center of gravity of the mounted optical module. To reduce or eliminate longitudinal vibrations each tine includes a first section and a second section, the first section attached to the second section by a U-shaped section.

### INTRODUCTION

The technical field generally relates to Light Detection and Ranging (LiDAR) resonators, and more particularly relates to a system and method of vibration and noise reduction in a LiDAR resonator.

The operation of modern vehicles is becoming more automated, i.e., able to provide driving control with less and less driver intervention. Such automation may include various automated driver-assistance systems, such as cruise control, adaptive cruise control, and parking assistance systems up to true “driverless” vehicles. To help achieve the various levels of automation may involve a variety of onboard sensors. LiDAR is a surveying technology that measures distance by illuminating a target with a laser light. LiDAR has a greater spatial resolution than a RADAR due to the shorter wavelength of the transmitted signal.

Current LiDAR systems use various motors to aim the laser lights across a field of view, which may produce various mechanical vibrations and noise that may be an irritant to passengers within the vehicle. Accordingly, it is desirable to provide a stable LiDAR scanning mechanism that avoids noise and vibration, while providing robust operation. Furthermore, other desirable features and characteristics of the present disclosure will become apparent from the subsequent detailed description and the appended claims, taken in conjunction with the accompanying drawings and the foregoing technical field and background.

### SUMMARY

An apparatus is provided herein for providing a LiDAR resonator with reduced audible noise and vibration. In an embodiment, the apparatus includes a spring fork mechanism that includes a first spring fork and a second spring fork. The first spring fork includes a first tine and a second tine. The second fork also includes a first tine and a second tine. The first tine of the first spring fork and the first tine of the second spring fork include a mounted optical module, configured to transmit a light pulse and receive a reflection of the light pulse. The second tine of the first spring fork and the second tine of the second spring fork include a mounted counterweight having a mass and center of gravity equal to a mass and center of gravity of the mounted optical module. Both the first spring fork and the second spring fork may be secured to a base. Each of the tines may also include a first section and a second section, where the first and second sections are attached using a U-shaped section.

Another aspect of the disclosure includes where the second section of each tine has a length that is greater than the length of the first section.

Another aspect of the disclosure includes where a stiffness of the first tine of the first spring fork is equal to a stiffness of the first tine of the second spring fork and a stiffness of the second tine of the first spring fork is equal to a stiffness of the second tine of the second spring fork.

Another aspect of the disclosure includes where the first spring fork and the second spring fork form part of a LiDAR resonator.

Another aspect of the disclosure includes where the first section of the first tine of both the first and second spring form mechanisms and the first section of the second tine of the first and second spring forks are oriented in a first plane.

Another aspect of the disclosure includes where the second section of the first tine of the first and second spring forks and the second section of the second tine of the first and second spring forks are oriented in a second plane.

Another aspect of the disclosure includes where the first and second plane are orthogonal to each other.

Aspects of the disclosure also include a method directed to a LiDAR resonator with reduced audible noise and vibration. Such a method may include mechanically coupling an optical module to a first tine of a first spring fork and a counterweight to a second tine of the first spring fork.

The method continues with mechanically coupling an optical module to a first tine of a first spring fork and a first tine of a second spring fork. The method continues by mechanically coupling a counterweight to a second tine of the first spring fork and a second tine of the second spring fork. The method continues with a vibrating of the first and second spring forks, concurrently, in both the horizontal and vertical planes. In addition, both the first spring fork and the second spring fork may be secured to a base. Further, each tine of both the first and second spring forks includes a first section and a second section, where the first section is attached to the second section by a U-shaped section.

Another aspect of the disclosure includes the method where the second section has a length greater than the length of the first section.

Another aspect of the disclosure includes the method where a stiffness of the first tine of the first spring fork is equal to a stiffness of the first tine of the second spring fork and a stiffness of the second tine of the first spring fork is equal to a stiffness of the second tine of the second spring fork.

Another aspect of the disclosure includes the method where the first spring fork and the second spring fork form part of a LiDAR resonator.

Another aspect of the disclosure includes the method where the first section of the first tine of the first and second spring forks and the first section of the second tine of the first and second spring forks may be oriented in a first plane.

Another aspect of the disclosure includes the method where the second section of the first tine of the first and second spring forks and the second section of the second tine of the first and second spring forks may be oriented in a second plane.

Another aspect of the disclosure includes the method where the first plane is orthogonal to the second plane.

Another aspect of the disclosure includes the method where the vibrating of the first spring fork and the second spring fork in the horizontal plane is at a first frequency and the vibrating of the first spring fork and the second spring fork in the vertical plane is at a second frequency.

Another aspect of the disclosure includes the method where the first frequency is different from the second frequency.

Another aspect of the disclosure includes a vehicle with a LiDAR based navigation system including a first spring fork having a first tine and a second tine and a second spring fork including a first tine and a second tine. The first spring fork and the second spring fork may be secured to a base. Further, each first tine and each second tine may include a first section and a second section, the first section attached to the second section by a U-shaped section. An optical module may be mounted to the first tine of the first spring fork and the first tine of the second spring fork, the optical module may also be used for transmitting a light pulse and receiving a reflection of the light pulse. A counterweight may be mounted to the second tine of the first spring fork and the second tine of the second spring fork, the counterweight having a mass and center of gravity equal to a mass and center of gravity of the optical module. The embodiment may also include a processor for generating a laser depth map in response to a transmission time of each light pulse and a detection time of each reflection of the light pulse; a memory for storing the laser depth map; and a vehicle controller, to receive the laser depth map, and generate a control command for the vehicle.

Another aspect of the disclosure is where the first tine of the first spring fork and the first tine of the second spring fork have a first stiffness, and wherein the second tine of the first spring fork and the second tine of the second spring fork mechanism have a second stiffness.

Another aspect of the disclosure may include where the first stiffness is equal to the second stiffness.

Another aspect of the disclosure may include where the first section and the second section that may be oriented in orthogonal planes.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an illustration of a LiDAR system, in accordance with the disclosure.

FIG. 2 is an exploded illustration of a LiDAR system, in accordance with the disclosure.

FIG. 3 is an illustration of a spring fork mechanism that includes a first and a second spring fork mounted to a base, in accordance with the disclosure.

FIG. 4 is a partial scanning pattern of a LiDAR system, in accordance with the disclosure.

FIG. 5 is a full scanning pattern of a LiDAR system, in accordance with the disclosure.

FIG. 6 is a two-dimensional rendering of a spring fork mechanism in a LiDAR system, in accordance with the disclosure.

FIGS. 7A, 7B, 7C, 7D, and 7E are time-based two-dimensional renderings of a spring fork mechanism in a LiDAR system, in accordance with the disclosure.

FIG. 8 is a three-dimensional illustration of a spring fork mechanism in a LiDAR system, in accordance with the disclosure.

FIG. 9 is a two-dimensional illustration of a spring fork mechanism in a LiDAR system, in accordance with the disclosure.

FIG. 10 depicts a flowchart of a method for a modified dual spring fork operation in a LiDAR system, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms.

Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

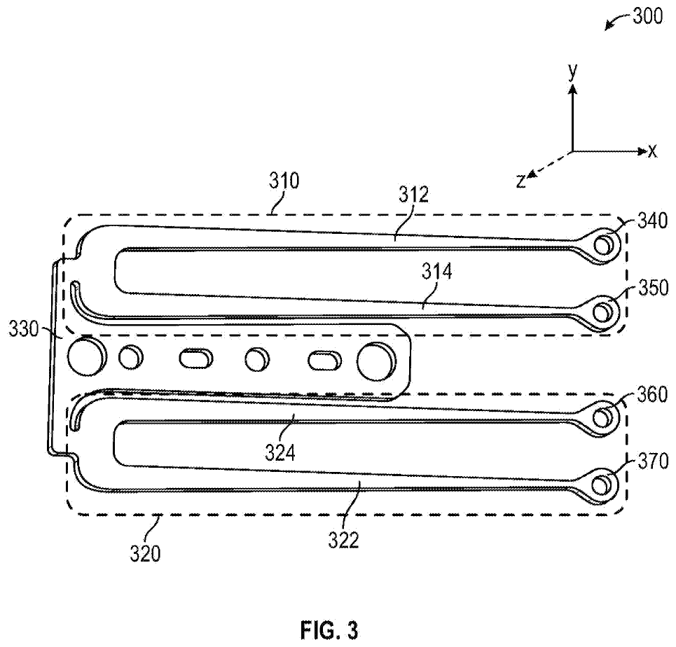

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may functionally be the same, but may be located at different points in a simulation arena).

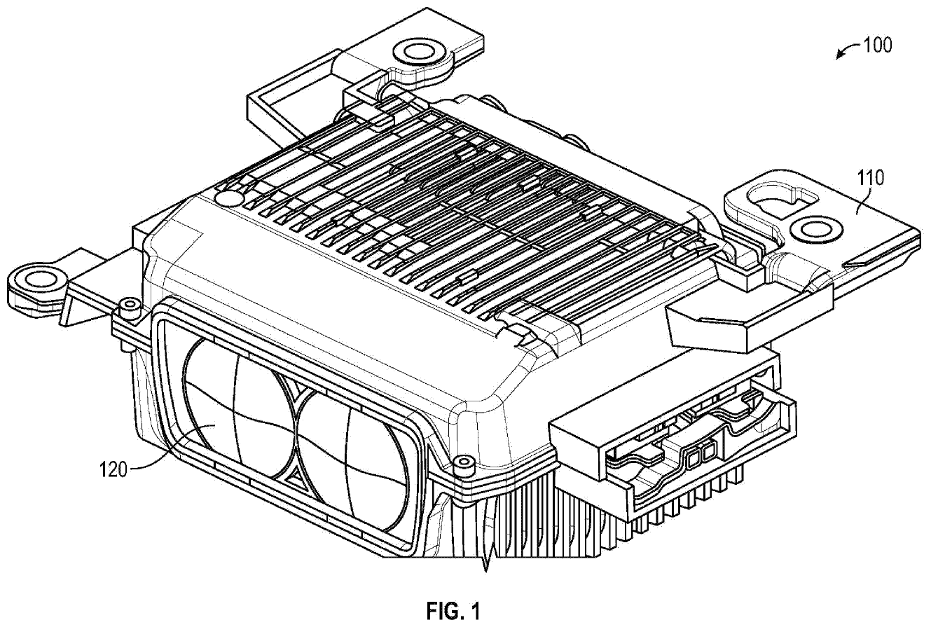

FIG. 1 is an illustration of a LiDAR navigation system 100, according to an embodiment of the present disclosure. LiDAR navigation system 100 is a representative example of a design that includes internal LiDAR scanning components (not shown) encased in a housing 110. Shown is lens module 120 through which a laser scan may be transmitted, and reflected portions of the transmitted laser scan may be received.

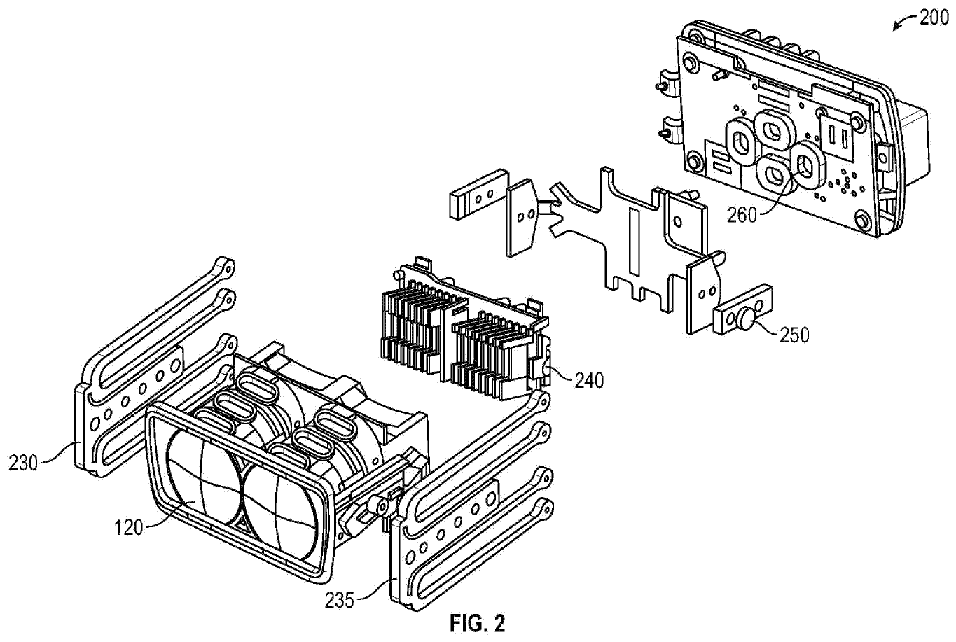

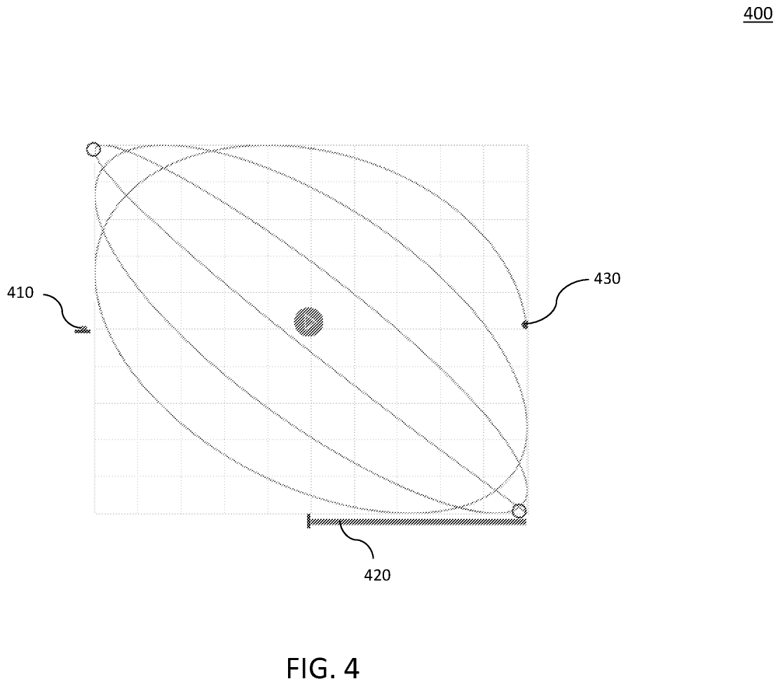

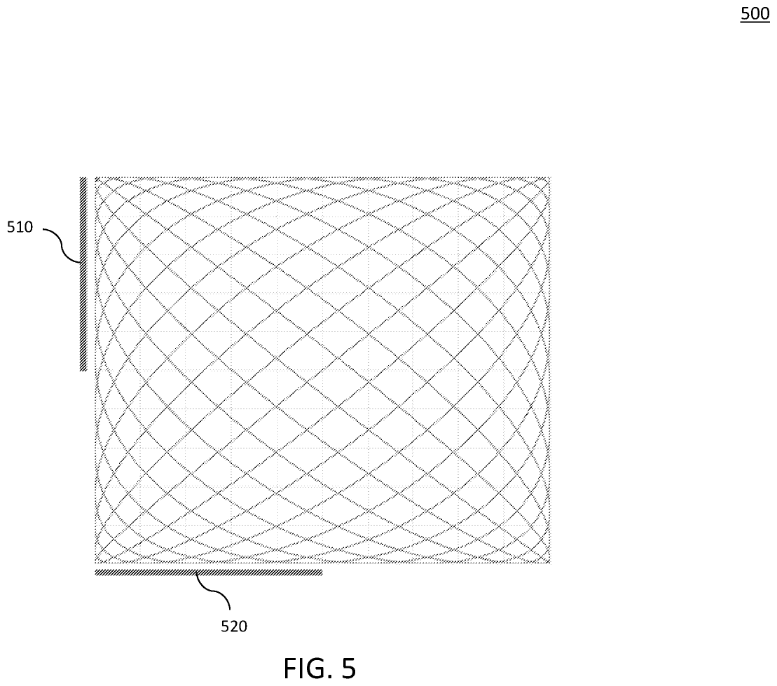

FIG. 2 is an exploded illustration of a LiDAR navigation system 200 highlighting some of the internal component parts, according to an embodiment of the present disclosure. LiDAR navigation system 200 may include a lens module 120, a dual spring fork 230, a dual spring fork 235, large motion optical component 240, large motion counterweight component 250, and motor module 260. LiDAR navigation systems generate a laser light that is sent from a source and reflected from objects in its field of vision. The reflected light is detected by a system and the time of flight is used to develop a distance map of the objects in the field of vision. In LiDAR navigation system 200, the dual spring fork 230, the dual spring fork 235, the large motion optical component 240, the large motion counterweight component 250, and the motor module 260 are used to direct a laser scan across a field of vision by shifting the laser light in both a horizontal plane and a vertical plane, which will be further explained in FIGS. 4 and 5.

FIG. 3 is an illustration of a spring fork mechanism 300, according to an embodiment of the disclosure. Spring fork mechanism 300 may include a first spring fork 310 and a second spring fork 320, where both the first spring fork 310 and the second spring fork 320 are attached to a base 330. Further, base 330 may be fixed to a housing of a LiDAR system, for example, the LiDAR navigation system 200. Each of the spring forks includes two tines. For example, the first spring fork 310 includes a first tine 312 and a second tine 314. The second spring fork 320 includes a first tine 322 and a second tine 324. At the distal ends of the tines there may be attaching points for other modules. For example, at attaching points 340 and 370, an optical module may be mounted. Further, at attaching points 350 and 360, a counterweight may also be mounted. In an embodiment, the counterweight may have a mass and center of gravity that is equal to the mass and center of gravity of the mounted optical module.

In an embodiment, spring fork mechanism 300 is vibrated such that the mounted optical module may scan a field of vision. In performing such a scan, the spring fork mechanism 300 may be vibrated in two planes, a vertical vibration in the y plane and a horizontal vibration in the z plane. As will be discussed, a byproduct of vibrating spring fork mechanism 300 in the y plane may be some unwanted longitudinal vibration in the x plane. In some instances, the longitudinal vibration may cause an undesired audible noise.

FIG. 4 is a partial scanning pattern 400 of a LiDAR system, according to an embodiment of the disclosure. Partial scanning pattern 400 is produced by moving an optical module, for example optical module 240, in this figure in a horizontal and vertical plane. A vertical position icon 410 may indicate the relative vertical position of a laser point source while horizontal position icon 420 may indicate the relative horizontal, or lateral, position of the laser point source in the optical module. By varying the frequencies at which horizontal and vertical components vibrate the shape of the scan may be controlled. The scan pattern may also be referred to as a Lissajous pattern. One embodiment, as represented in FIG. 4 is where the laser point source moves in the lateral plane at a 115 Hz rate while the laser point source moves in the vertical plane at a 125 Hz rate. In this example, as it is a partial scanning pattern, the scan is shown stopped at 430.

FIG. 5 is a full scanning pattern 500 of a LiDAR system, according to an embodiment of the disclosure. In one embodiment a full scanning pattern 500 may be accomplished in approximately 100 ms. As in FIG. 4, FIG. 5 also indicates the position of a laser point source by vertical position icon 510 and horizontal position icon 520.

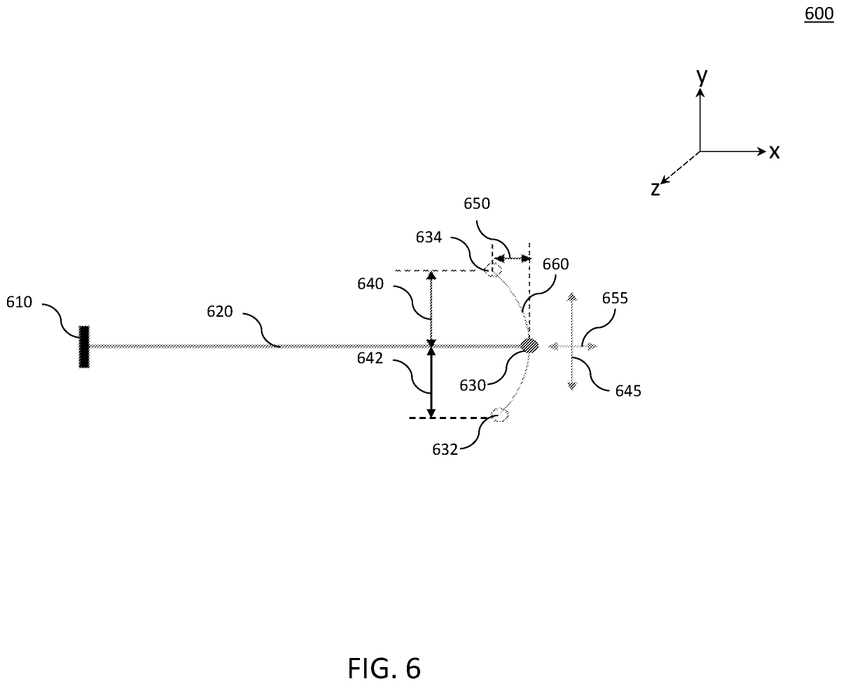

FIG. 6 is a two-dimensional rendering of a spring fork mechanism 600 in a LiDAR system, according to an embodiment of the present disclosure. FIG. 6 represents the spring fork mechanism of FIG. 3 that includes base 610, spring fork 620 with a center of gravity 630, where the center of gravity 630 (CG 630) represents the center of gravity of spring fork 620 and other components, for example the mounted optical module and the mounted counterweight. As discussed in FIGS. 4 and 5, the spring fork mechanism may control the position of a laser light source to generate a scan of a field of vision. A vertical movement in they plane, also indicated by a vertical direction 645, may also be accompanied by a horizontal movement in the z plane to produce a LiDAR scan as illustrated in FIG. 5.

In a perfect world a vertical movement of the CG 630 of the spring fork mechanism 600 would be just in the vertical y plane. However, in reality, as the length of spring fork 620 is fixed, when CG 630 moves up or down in they plane, CG 630 will move along the path of arc 660. Thus, when CG 630 is at the top of travel, at point 634, CG 630 indicates a vertical distance moved of distance 640. However, in addition to the vertical distance 640, CG 630 also indicates a longitudinal movement of distance 650 shown in the longitudinal direction 655. Similarly, when CG 630 traverses down to the point 632, CG 630 indicates traveling a vertical distance 642 along with a longitudinal movement of distance of 650.

The longitudinal movement of distance 650 of spring fork mechanism 600 may produce a second harmonic vibration represented by the following equation:

x≈z²/2R

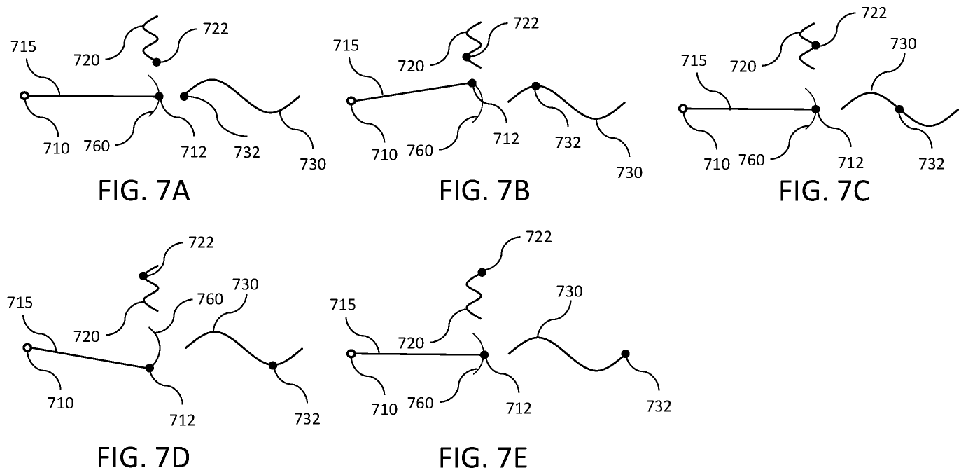

X represents the longitudinal displacement distance 650, z represents the vertical displacement distance 640 and R represents the length of the spring fork 620 from the base 610 to the CG 630. Further, the longitudinal vibration produces a second harmonic, as will be shown in FIG. 7, when one cycle of movement of CG 630 in the vertical direction 645 produces two cycles of movement in the longitudinal direction 655.

FIGS. 7A, 7B, 7C, 7D, and 7E are time-based two-dimensional renderings of a spring fork mechanism in a LiDAR system in an embodiment according to the disclosure. These figures illustrate why a single cycle 730 of spring fork 715 may produce a second harmonic longitudinal vibration cycle 720. Also illustrated are base 710, center of gravity 712 (CG 712), and travel arc 760 of the CG 712.

A cycle of the spring fork mechanism, e.g., spring fork 715 and a corresponding optical module and counterweight, may start with FIG. 7A with CG 712 at the center position of travel arc 760 with the single cycle indicator 732 at the start of single cycle 730 and two-cycle indicator 722 at the start of the second harmonic longitudinal vibration cycle 720. For clarification, single cycle 730 may be indicative of the vertical component of movement of CG 712 while the second harmonic longitudinal vibration 720 may be indicative of the longitudinal, or horizontal, movement, i.e., vibrational component, of CG 712.

As CG 712 moves to the top in FIG. 7B of travel arc 760, single cycle indicator 732 moves to the peak of single cycle 730 while the two-cycle indicator 722 is at the top of the first cycle of the second harmonic longitudinal vibration cycle 720.

As CG 712 moves back to the center in FIG. 7C of travel arc 760, single cycle indicator 732 moves to the mid-point of single cycle 730 while the two-cycle indicator 722 is back at the center of the second harmonic longitudinal vibration cycle 720.

As CG 712 moves into the lower portion of the first vertical cycle in FIG. 7D of travel arc 760, single cycle indicator 732 moves to the valley of single cycle 730 while the two-cycle indicator 722 is at the top of the second cycle of the second harmonic longitudinal vibration cycle 720.

As CG 712 moves to complete the first vertical cycle in FIG. 7E of travel arc 760, single cycle indicator 732 moves to the end of single cycle 730 while the two-cycle indicator 722 completes the second cycle of the second harmonic longitudinal vibration cycle 720.

Thus, as discussed as an example in FIG. 4, if the vertical scanning frequency of the laser point source was at a 125 Hz rate, then a second harmonic longitudinal vibration cycle might be expected at approximately a 250 Hz frequency.

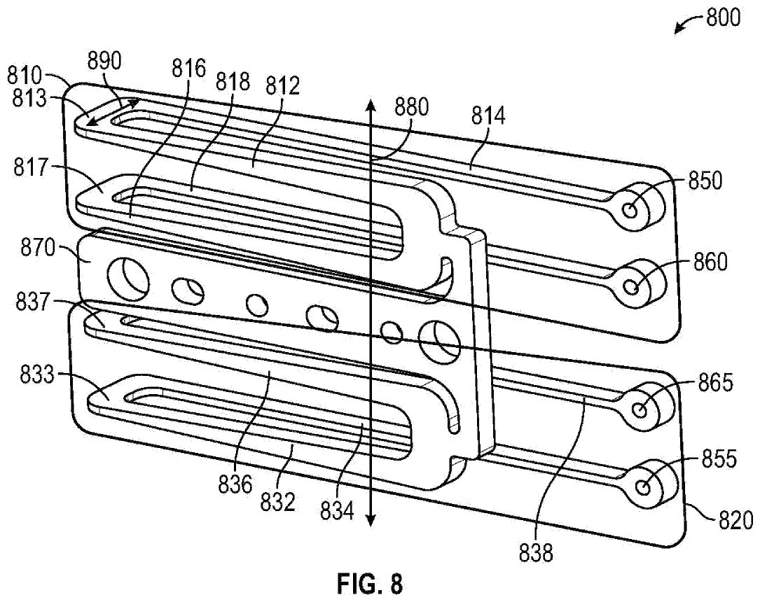

FIG. 8 is a three-dimensional illustration of a spring fork mechanism 800 in a LiDAR system, in an embodiment according to the disclosure. Spring fork mechanism 800 may be designed to minimize or eliminate the second harmonic longitudinal vibrations previously discussed. Spring fork mechanism 800 includes a first spring fork 810 and a second spring fork 820. The use of two spring forks in the spring fork mechanism 800 is just an example and not meant to be limiting. A single spring fork or greater than two spring forks is also possible and would exhibit the same or similar characteristics as would be known by a person of ordinary skill in the art.

First spring fork 810 may also include a first tine and a second tine. The first tine may include a first section 812 and a second section 814 where the first section 812 is attached to the second section 814 by a U-shaped section 813. In an analogous manner, the second tine may include a first section 816 and a second section 818 where the first section 816 is attached to the second section 818 by a U-shaped section 817. In an embodiment, the second section 814 is longer than the first section 812, and similarly with second sections 818, 834, 838. The length and stiffness of the sections may be used to tune the spring forks and may be dependent on the size and weights of the optical modules and counterweights in a LiDAR resonator system.

Second spring fork 820 may also include a first tine and a second tine. The first tine may include a first section 832 and a second section 834 where the first section 832 is attached to the second section 834 by a U-shaped section 833. In a comparable manner, the second tine may include a first section 836 and a second section 838 where the first section 836 is attached to the second section 838 by a U-shaped section 837.

Further, the first tine of the first spring fork 810 and the first tine of the second spring fork 820 may include a mounted optical module, mounted at mounting point 850 and mounting point 855. The mounted optical module may be configured to transmit a light pulse, e.g., a laser light pulse, and to also receive a reflection of that light pulse. In addition, the second tine of the first spring fork 810 and the second tine of the second spring fork 820 may include a mounted counterweight, mounted at mounting point 860 and mounting point 865. The counterweight may have a mass and center of gravity equal to a mass and center of gravity of the mounted optical module. Lastly, the first spring fork 810 and the second spring fork 820 may be secured to a base 870.

In an embodiment, the first section of the tines may be oriented in the same plane, for example, first section 812, first section 816, first section 832, and first section 836 may be oriented in first plane 880. In the same embodiment, the second section of the tines may be oriented in the same plane, for example, second section 814, second section 818, second section 834, and second section 838 may be oriented in second plane 890. Further, in an embodiment first plane 880 may be oriented orthogonally to the second plane 890.

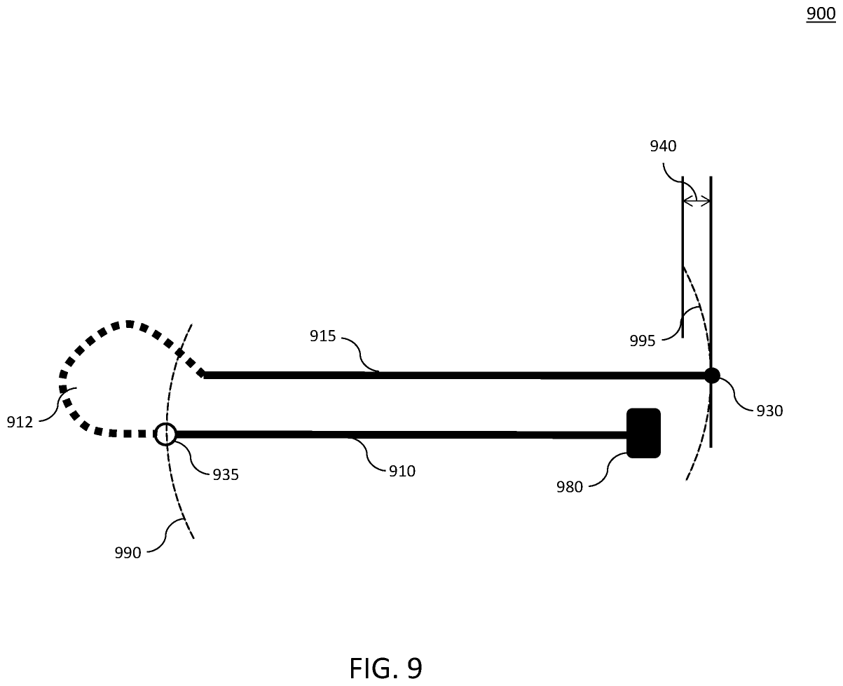

FIG. 9 is a two-dimensional illustration of a spring fork mechanism 900 in an embodiment according to the disclosure. FIG. 9 is a representation of an embodiment of the spring fork mechanism in FIG. 8 but illustrated as a single spring fork for simplicity. Spring fork mechanism 900 may include a first section 910, a second section 915, where the first section 910 may be connected or attached to the second section 915 by a U-shaped section 912. Further, first section 910 may be attached to base 980. In addition, a center of gravity 930 (CG 930) is shown that indicates the center of gravity of spring fork mechanism 900 that includes an optical module and a counterweight (not shown), but as discussed in at least FIG. 2.

In FIG. 6 a vertical movement of CG 630 of the spring fork mechanism 600 CG 630 will move along the path of arc 660. Further, the movement of spring fork 620 is constrained by the stiffness of spring fork 620. Similar principles are applicable in FIG. 9. For example, a vertical movement of CG 930 will create a horizontal force on CG 930, in this example pushing CG 930 to the left, such that CG 930 tracks along arc 995, resulting in a horizontal displacement amount of up to distance 940.

However, spring fork mechanism 900 may include the semi-flexible U-shaped section 912. The flexibility, or stiffness, or U-shaped section 912 may also be a factor pertaining to first section 910 and second section 915. In an embodiment, the stiffness of one spring fork, e.g., spring fork 810 may be the same stiffness, or stiffer, or less stiff, than that of another spring fork, e.g., spring fork 820.

In an embodiment, while a vertical movement of CG 930 creates a left directional force, the vertical movement of CG 930 also creates a vertical movement of the first section 910, and to some degree U-shaped section 912, at point 935. Thus, for example, an upward vertical movement of CG 930 will exert a force of CG 930 to follow arc 995, an opposing force will be exerted at point 935 forcing point 935 to follow arc 990. Arc 990 may be in the opposite direction of arc 995, thus cancelling the horizontal movement of CG 930, resulting in a diminishing or cancellation of longitudinal movement of CG 930.

Cancellation of the longitudinal movement of CG 930 may depend on the stiffness and length of the first section 910 and the second section 915 and may be adjusted to decrease or eliminate the longitudinal movement. Cancellation or minimization of longitudinal movement may also have the effect of eliminating audible noise created by the longitudinal movement.

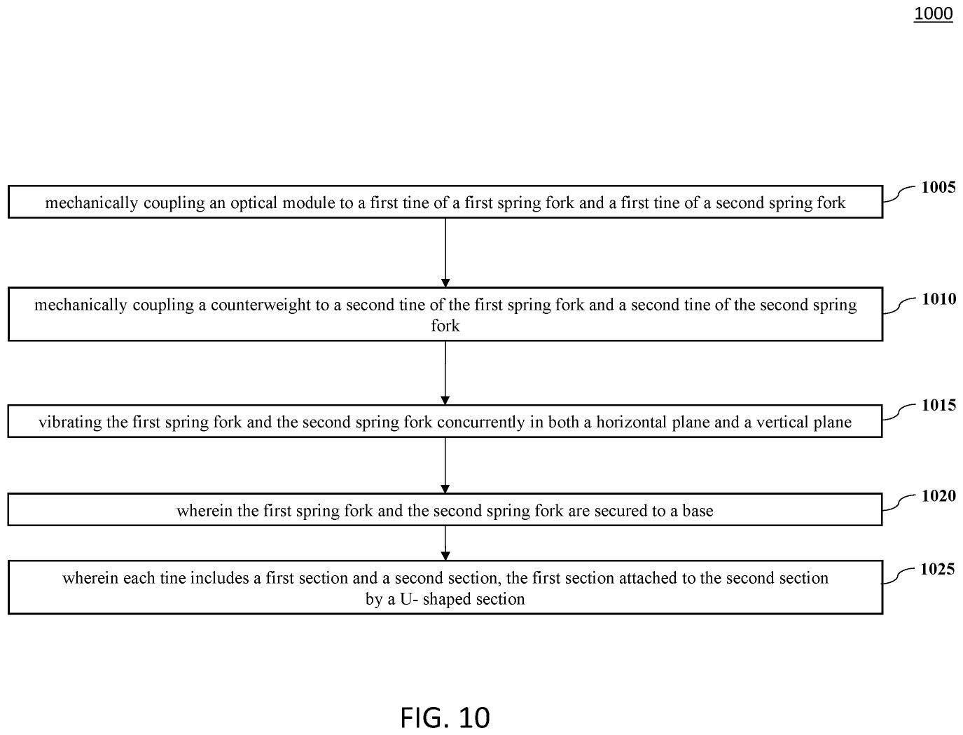

FIG. 10 shows an exemplary embodiment of a method 1000 for vibration and audible noise reduction in a LiDAR resonator. Method 1000 begins at step 1005 by mechanically coupling an optical module to a first tine of a first spring fork and a first tine of a second spring fork. A LiDAR system may utilize a tuned fork spring system with a counterweight and optical module that vibrate in a vertical and lateral axis. The counterweight and optical modules may be mounted to multiple fork springs. For example, spring fork 810 and spring fork 820 may be connected to an optical module at mounting point 850 and mounting point 855. In an embodiment there may be two mounting points for an optical module. However, in other embodiments there may be fewer or greater number of mounting points dependent on a configuration of the optical module.

Step 1010 may include a mechanically coupling of a counterweight to a second tine of the first spring fork and a second tine of the second spring fork. Again, as shown if FIG. 8, the spring fork 810 and spring fork 820 may be connected to a counterweight at mounting point 860 and mounting point 865. In an embodiment there may be two mounting points for a counterweight. However, in other embodiments there may be fewer or greater number of mounting points dependent on a configuration of the counterweight.

Step 1015 may include a vibrating of the first spring fork and the second spring fork concurrently in both a horizontal plane and a vertical plane. As discussed in FIG. 4, a Lissajous pattern may be generated by vibrating a laser point source in both a lateral and vertical plane concurrently. For example, in one embodiment the laser point source moves in the lateral plane at a 115 Hz rate while the laser point source moves in the vertical plane at a 125 Hz rate.

Step 1020 may include a securing of the first spring fork and the second spring fork to a base. As discussed in FIG. 3, base 330 may be fixed to a housing or other component within a LiDAR system. However, the base may be a non-movable fixing point relative to the spring forks.

Step 1025 may include where each tine includes a first section and a second section, the first section attached to the second section by a U-shaped section. As discussed in FIG. 8, a goal of the spring fork mechanism 800 may be to reduce or eliminate longitudinal vibrations in a LiDAR system, which may also reduce or eliminate audio noise from the spring fork mechanism 800 created by longitudinal vibrations. Further, a reduction in longitudinal vibrations may also reduce stress, fatigue, and failure of the unit. Spring fork mechanism 800 may include a first spring fork 810 and a second spring fork 820 where each spring fork may include two tines. Each tine may include a first section and a second section, e.g., a first section 832 and a second section 834 where the first section 832 is attached to the second section 834 by a U-shaped section 833.

The construction of a first section and a second section connected by a U-shaped section may produce opposing forces on the distal ends of the spring forks, thereby reducing or eliminating longitudinal vibrations. Method 1000 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. An apparatus comprising:
a spring fork mechanism including a first spring fork and a second spring fork;
the first spring fork having a first tine and a second tine;
the second spring fork having a first tine and a second tine;
wherein the first tine of the first spring fork and the first tine of the second spring fork include a mounted optical module, configured to transmit a light pulse and receive a reflection of the light pulse,
wherein the second tine of the first spring fork and the second tine of the second spring fork include a mounted counterweight having a mass and center of gravity equal to a mass and center of gravity of the mounted optical module, and
wherein the first spring fork and the second spring fork are secured to a base and wherein each tine includes a first section and a second section, the first section attached to the second section by a U-shaped section.

2. The apparatus of claim 1, wherein the second section has a length greater than the length of the first section.

3. The apparatus of claim 1, wherein a stiffness of the first tine of the first spring fork is equal to a stiffness of the first tine of the second spring fork and a stiffness of the second tine of the first spring fork is equal to a stiffness of the second tine of the second spring fork.

4. The apparatus of claim 1, wherein the first spring fork and the second spring fork forms part of a LiDAR resonator.

5. The apparatus of claim 1, wherein the first section of the first tine of the first and second spring forks and the first section of the second tine of the first and second spring forks are oriented in a first plane.

6. The apparatus of claim 5, wherein the second section of the first tine of the first and second spring forks and the second section of the second tine of the first and second spring forks are oriented in a second plane.

7. The apparatus of claim 6, wherein the first plane is orthogonal to the second plane.

8. A method comprising:
mechanically coupling an optical module to a first tine of a first spring fork and a first tine of a second spring fork;
mechanically coupling a counterweight to a second tine of the first spring fork and a second tine of the second spring fork; and
vibrating the first spring fork and the second spring fork concurrently in both a horizontal plane and a vertical plane,
wherein the first spring fork and the second spring fork are secured to a base, and
wherein each tine includes a first section and a second section, the first section attached to the second section by a U-shaped section.

9. The method of claim 8, wherein the second section has a length greater than the length of the first section.

10. The method of claim 8, wherein a stiffness of the first tine of the first spring fork is equal to a stiffness of the first tine of the second spring fork and a stiffness of the second tine of the first spring fork is equal to a stiffness of the second tine of the second spring fork.

11. The method of claim 8, wherein the first spring fork and the second spring fork form part of a LiDAR resonator.

12. The method of claim 8, wherein the first section of the first tine of the first and second spring forks and the first section of the second tine of the first and second spring forks are oriented in a first plane.

13. The method of claim 8, wherein the second section of the first tine of the first and second spring forks and the second section of the second tine of the first and second spring forks are oriented in a second plane.

14. The method of claim 8, wherein the first plane is orthogonal to the second plane.

15. The method of claim 8, where the vibrating of the first spring fork and the second spring fork in the horizontal plane is at a first frequency and the vibrating of the first spring fork and the second spring fork in the vertical plane is at a second frequency.

16. The method of claim 15, wherein the first frequency is different from the second frequency.

17. A vehicle comprising:
a LiDAR based navigation system including a first spring fork having a first tine and a second tine and a second spring fork with a first tine and a second tine, wherein the first spring fork and the second spring fork are secured to a base, wherein each first tine and each second tine include a first section and a second section, the first section attached to the second section by a U-shaped section;
an optical module mounted to the first tine of the first spring fork and the first tine of the second spring fork, the optical module configured for transmitting a light pulse and receiving a reflection of the light pulse;
a counterweight mounted to the second tine of the first spring fork and the second tine of the second spring fork, the counterweight having a mass and center of gravity equal to a mass and center of gravity of the optical module;
a processor for generating a laser depth map in response to a transmission time of each light pulse and a detection time of each reflection of the light pulse;
a memory for storing the laser depth map; and
a vehicle controller, to receive the laser depth map, and generate a control command for the vehicle.

18. The vehicle of claim 17, wherein the first tine of the first spring fork and the first tine of the second spring fork have a first stiffness, and wherein the second tine of the first spring fork and the second tine of the second spring fork have a second stiffness.

19. The vehicle of claim 18, wherein the first stiffness is equal to the second stiffness.

20. The vehicle of claim 17, wherein first section and the second section are oriented in orthogonal planes.
